(19) United States
(12) Patent Application Publication
(10) Pub. No.: US 2004/0073943 A1
(43) Pub. Date: Apr. 15, 2004

(54) Set-top box video pump

(76) Inventors: Thomas Poslinski, San Diego, CA (US); Kim Annon Ryal, Poway, CA (US)

Correspondence Address: WAGNER, MURABITO & HAO LLP, Third Floor, Two North Market Street, San Jose, CA, 95113, US

(21) Appl. No.: 10/269,595

(22) Filed: Oct. 11, 2002

(51) Int. Cl. H04N 7/173; H04N 7/16

(52) U.S. Cl. 725/131; 725/100; 725/88; 725/134; 725/151

(57) ABSTRACT

A media reading apparatus is described. In one embodiment, a media reading apparatus is comprised of a reading component adapted to read data from a media storage device. The reading can be at a selectable accelerated playback speed. The media reading apparatus also includes a digital encoder, coupled with the reading component and a data pump, adapted to digitally encode data read by the reading component. The encoding is performed at a corresponding selectable accelerated speed. The data pump is for synchronizing encoded media with and for transferring encoded media to a data storage device of a digital terminal device and for receiving encoded data from the data storage device and transferring the encoded data back to the digital encoder. The media reading apparatus also includes a high speed communication channel, coupled to said data pump and the digital terminal device, which enables high speed transference of the encoded data to and from the data storage device of the digital terminal device.

### FIELD OF THE INVENTION

The present invention relates to digital terminal devices, also called intelligent transceivers or set top boxes, specifically with regard to bi-directional set top boxes. More particularly, embodiments of the present invention provide digital conversion of data for a digital terminal device.

### BACKGROUND OF THE INVENTION

Digital broadcast systems include direct broadcast digital satellite systems, interactive World Wide Web access systems, and digital cable systems. Digital broadcasting provides a number of advantages to subscribers, such as variety and flexibility of programming, useful and comprehensive support services (such as detailed electronic programming guides), superior audio and video quality, compatibility with computers and the Internet, and consistency of reception over varying distances. Further, with the development and acceptance of digital television, other related products to be implemented in conjunction with this new television medium have been developed and made available to the consumer. One such product developed for use with new television medium is the intelligent transceiver, commonly referred to as a digital terminal device or a set top box. Subscribers receive broadcast digital signals via set-top boxes or other similar consumer electronic equipment (generally, a “transceiver”) located in the subscriber's home. In an intelligent set-top box, information and instructions associated with receiving and processing digital broadcast signals are stored in a memory unit of the set-top box and are executed by a processor.

FIG. 1A is a prior art block diagram of some components contained within and associated with an exemplary digital terminal device, such as a set top box 10. DTD (digital terminal device) 10 is pictured as having read only memory (ROM) 12 that may contain initial start-up instructions, flash memory 14, a non-volatile memory that can contain application software, SDRAM 16 (synchronous dynamic random access memory), and CPU 18 (central processing unit/processor) all communicatively coupled through bus 20. Central processing unit 18 also may contain random access memory, read only memory, one or more caches, a flash memory and the like (not shown) for storing information and instructions.

Still referring to FIG. 1A, also shown in DTD (digital terminal device)10 is a data storage device 22 for storing data and coupled to bus 20. Data storage device 22 can be a hard disk drive and in one implementation can be removable. An MPEG (moving picture experts group) decoder, e.g., decoder 24 is also shown coupled with bus 20. Decoder 24 is for decoding data received by DTD 10.

A set-top box performs a number of functions associated with processing a broadcast digital signal. Typically, a digital signal is received by a set-top box, e.g., DTD 10, in an encrypted compressed MPEG format for security reasons, and the signal is decoded by the set-top box before further processing occurs. The decoded signal is then encrypted within the set-top box in order to prevent unauthorized duplication and use (“pirating”) of the decoded signal. Once the encrypted signal is at a more secure location within the set-top box, it is decrypted for further processing. The digital signal is typically in a compressed data format such as MPEG for video signals and/or Dolby AC3 for audio signals, and so the decrypted signal is decoded (uncompressed) by the set-top box. After decoding, the audio content and video content contained in the digital signal are processed so that it can be viewed and/or listened to by the subscriber using, for example, a television set.

A digital terminal device, such as a bi-directional set top box is designed to provide interactivity between the subscriber and the digital broadcast system operator (commonly known as the MSO, or Multiple System Operator). The bi-directional capabilities of the set top box provide a subscriber many different options and functions from which to select. A subscriber may select a premium service offered by the MSO, such as a pay-per-view movie or event. A subscriber may watch a television show that includes viewer interactivity, such as a game show or a quiz show. The subscriber may, while watching a sporting event, utilize the instant replay capability of the bi-directional set top box. A subscriber may wish to see the provided electronic programming guide for the week, and predetermine which, if any, shows they might want to view. Other options and functions include accessing the Internet, listening to a variety of available music, and the like.

The growth of digital terminal devices has further spawned an influx in new applications being designed for use in conjunction with bi-directional set top boxes. Some of the applications being developed include advanced graphic production, video-on-demand and near-video-on-demand, and enhanced music and video entertainment. Utilizing the functionalities provided by the above listed applications, a user or subscriber is able to select what data, e.g., audio or video, is played, and the order in which the data is played. Additionally, some applications enable a user to edit video and audio data.

By virtue of this advanced selectability, many subscribers/users desire to import archived data, e.g., audio/video tape, to a DTD and convert the data into a digital format for editing and customized playback. Current methods import data to a DTD, as shown in FIG. 1B, by connecting a video recorder, e.g., a camcorder 11, to a DTD 10, via a connection 5, and then exporting the data contained in a media storage device, e.g., video cassette 12, to DTD 10. To import data from cassette 12, cassette 12 is inserted into camcorder 11, and then camcorder 11 is used to access and import the data therein to DTD 10. The imported data is converted to digital format by encoder 24 (FIG. 1A) of DTD 10.

It is noted that current methods for importing data, such as described above, have a time ratio of 1:1. This means that it takes one hour of import time for every hour of tape playback, two hours of import time for two hours of tape playback, and so on. Further, when factoring in the time required to encode the data, e.g., convert the data into a digital format, e.g., MPEG, the importing and conversion process can be quite time consuming for the user. While this one-to-one time ratio is adequate for some, many other users find these current methods slow and tedious. This is especially prevalent with users that desire to import and convert large amounts of data, such as numerous audio and/or video tapes.

Additionally, current importing and conversion methods do not provide for reverse conversion, meaning that once the data has been digitally encoded and then edited or altered in some manner, there is no convenient or rapid means to decode the digitally encoded and edited data back into its original format, and then write that decoded data back to the storage media from which it came.

Accordingly, conventional data importing and conversion methods are inefficient. Further, current methods of data importing and conversion do not provide for reconversion to an original format.

### SUMMARY OF THE INVENTION

Thus, a need exists for an improved apparatus and method for converting data into a digitally encoded format and importing the encoded data into a digital terminal device. A further need exists for an apparatus and method for importing and converting data in which converted data can be reconverted into its original format and written back onto the medium from which it came. Yet another need exists for an apparatus and method that can accomplish the above listed needs in an accelerated manner.

Accordingly, embodiments of the present invention are drawn to providing an apparatus and method for converting data into digitally encoded data and transferring that encoded data to a digital terminal device at a rate faster than the original playback rate. Embodiments of the present invention are also drawn to providing an apparatus and method for decoding encoded data back into its original format.

In one embodiment, a media reading apparatus is comprised of a reading component. The reading component is adapted to read data from a media storage device. The reading can be at a selectable accelerated playback speed. The media reading apparatus also includes a digital encoder coupled with the reading component and is adapted to digitally encode data read by the reading component. The encoding is performed at a corresponding selectable accelerated speed. The media reading apparatus includes a data pump coupled with the digital encoder. The data pump is for synchronizing encoded media with and for transferring encoded media to a data storage device of a digital terminal device. The media reading apparatus also includes a high speed communication channel coupled to the data pump and the digital terminal device. The high speed communication channel enables high speed transference of the encoded data to the data storage device of the digital terminal device.

Advantageously, embodiments of the present invention provide accelerated playback of data and correspondingly accelerated digital encoding of the data. Embodiments of the present invention also provide for accelerated transference of encoded data to a digital terminal device for editing by a user. Embodiments of the present invention further provide for decoding of edited encoded data and writing of the decoded data to the media storage device from which the data originally came, also at correspondingly accelerated speeds.

These and other objects and advantages of the present invention will no doubt become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1A (PRIOR ART) is an illustration of components in an exemplary digital terminal device.

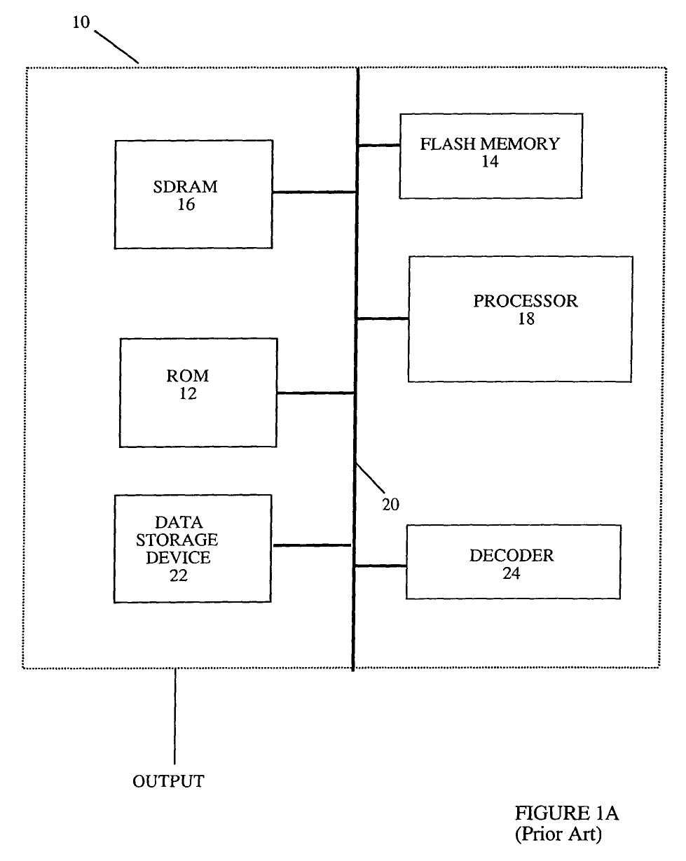

FIG. 1B (PRIOR ART) is a block diagram of components in an exemplary environment for importing data to a digital terminal device.

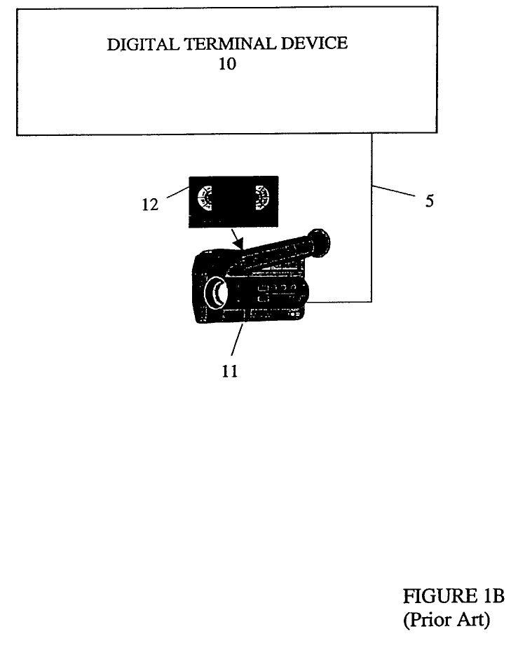

FIG. 2 is a block diagram of a media reading apparatus and a digital terminal device in an environment for converting and importing data to the digital terminal device, in accordance with one embodiment of the present invention.

FIG. 3 is a block diagram of a media reading apparatus configured with a plurality of receiving slots and coupled to a digital terminal device in an environment for converting and importing data to the digital terminal device, in accordance with one embodiment of the present invention.

FIG. 4 is a block diagram of components and circuitry of a media reading apparatus, in accordance with one embodiment of the present invention.

FIG. 5 is a block diagram of components and circuitry of a digital terminal device adapted to receive data from the media reader of FIGS. 2-4, in accordance with one embodiment of the present invention.

FIG. 6 is a data flowchart depicting the flow of data in a data conversion and importing process, in accordance with one embodiment of the present invention.

FIG. 7 is a flowchart depicting the steps in a process of converting and importing data to a digital terminal device, in accordance with one embodiment of the present invention.

### DETAILED DESCRIPTION

A media reading apparatus and method for converting data and importing that converted data to a digital terminal device is described. In the following description, for purposes of explanation, numerous specific details are set forth in order to provide a thorough understanding of the present invention. It will be obvious, however, to one skilled in the art that the present invention may be practiced without these specific details. In some instances, well-known structures and devices are shown in block diagram form in order to avoid obscuring the present invention. In other instances, well know methods, procedures, components, and circuits have not been shown or described in detail so as not to unnecessarily obscure aspects of the present invention.

The present invention, a media reading apparatus, is discussed primarily in the context of a digital terminal device, such as an intelligent transceiver or a bi-directional set top box, or an electronic computer system. However, it is appreciated that the present invention can be used with other types of devices that have the capability to access digital storage media, including but not limited to digital terminal devices, such as set top boxes.

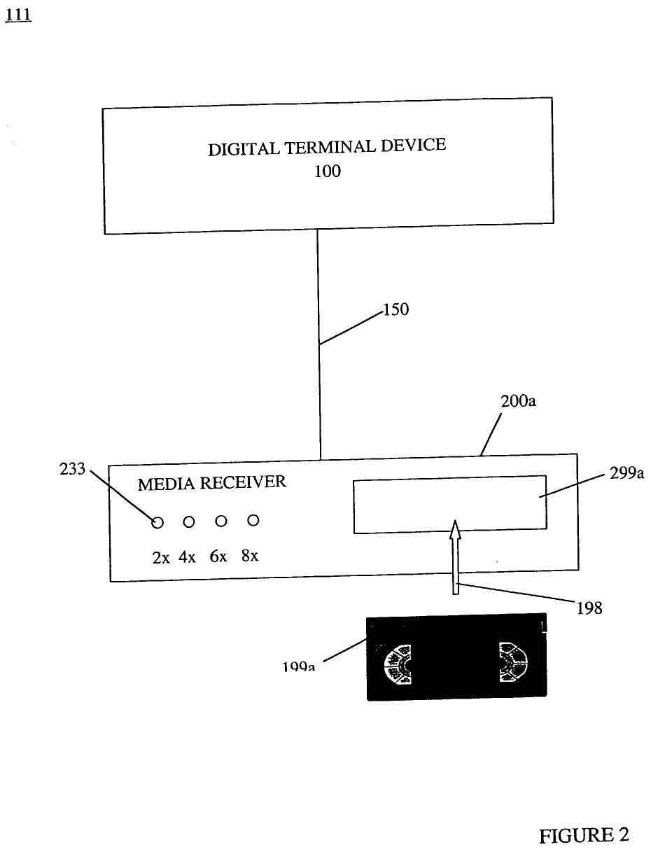

FIG. 2 is a block diagram of an environment, e.g., environment 111, for converting and importing data to a digital terminal device, in one embodiment of the present invention. Shown in environment 111 is a digital terminal device 100. Digital terminal device 100 can, in one embodiment, be a set top box. In another embodiment, digital terminal device 100 can be an electronic computer system, such as a desktop, laptop, and/or a workstation computer system.

Still referring to FIG. 2, shown coupled to digital terminal device 100 is a media reading apparatus 200 which can receive a removable data storage device, in one embodiment of the present invention. Media reading apparatus 200 is coupled to digital terminal device 100 via a high speed communication channel, channel 150.

In one embodiment, communication channel 150 is a USB (universal serial bus) 2 bus. A USB 2 bus, also referred to as a HiSpeed USB, provides transfer rates of approximately 480 Mbps (megabits per second), and is backward compatible with USB 1.1, which has a transfer rate ranging from 1.1 to 12 Mbps, depending upon implementation. In another embodiment, communication channel 150 is an IEEE 1394 bus. An IEEE 1394 bus provides a transfer rate of approximately 400 Mbps. It is noted that alternative high speed communication channels can also be implemented as connection 150, provided the alternative communication channel provides analogous functionality and characteristics as those provided by communication channel 150.

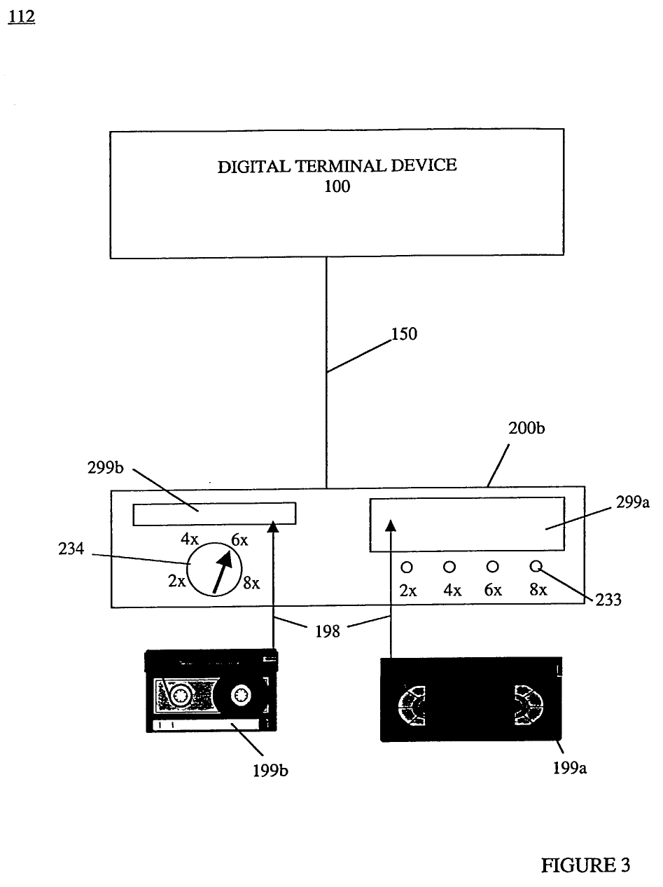

Referring still to FIG. 2, media reading apparatus 200 can have a receiver slot 299, e.g., receiving slot 299a. Receiving slot 299a is adapted to have inserted therein a removable media storage device 199, e.g., media storage device 199a. Media storage device 199 can, in one example, be a video tape, e.g., a VHS tape, or equivalent. Media storage device 199 can, in another example, be an audio tape, e.g., a cassette tape 199b. In another example, media storage device 199 can be an 8 mm tape. In yet another example, media storage device can be a digital 8 mm tape. In still another example, media storage device 199 can be a DVD (digital video disc). In yet another example, media storage device 199 can be a memory stick or other flash memory device. In one embodiment, each receiving slot 299 and each reader/writer 202 are adapted to receive and interact with a particular media storage device, e.g., receiving slot 299a is adapted to receive a media storage device 199a, whereas a receiving slot 299b is adapted to receive a media storage device 199b, as shown in FIG. 3, and so on. Accordingly, reader/writer 204 would be configured to read from and write to a media storage device 199, such that each type of media storage device can be read from and written to by a reader/writer 204 when reader/writer 204 is properly configured for that type of media storage device. It is noted that in one embodiment, media reading apparatus 200 can contain one receiving slot 299, receiving slot 299a, as shown in FIG. 2. In another embodiment, media reading apparatus 200 can have disposed therewith a plurality of receiving slots 222, e.g., receiving slots 299a and 299b, as shown in media reading apparatus 200b of FIG. 3.

Referring still to FIG. 2, media reading apparatus 200 can, in one embodiment of the present invention, have a plurality of buttons 233 for selecting the speed with which the data on a received media storage device 199 can be read. In one example, the speed with which media reader 200 can read the data on a received media storage device 199 can be two times normal speed, four times, six times or eight times normal speed. In another embodiment, the media storage device 199 can dictate to media reading apparatus 200 the preferred speed with which the data is read. In another embodiment, media reading apparatus 200 can be configured with an override mechanism, enabling a user to determine alternative speeds with which the data can be read.

It is noted that the speeds with which the data can be read, as described above, are exemplary in nature. Accordingly, those speeds should not be construed as limiting but rather considered illustrative. Further, many alternative means to select the speed can be implemented including, but not limited to, a plurality of buttons 233, as shown in FIGS. 2 and 3, as well as a dial selector 234, also shown in FIG. 3. In one embodiment, selecting the speed with which media reading apparatus 200 is to read the data on a received media storage device 199 can initiate the reading (and writing), thus obviating a need for buttons or levers to control the starting, stopping, playing, fast forwarding, and the like, of media storage device 199. In another embodiment, those buttons/levers can be disposed upon a facial surface of media reading apparatus 200, but are not shown to more clearly describe and depict the functionality provided by embodiments of the present invention.

FIG. 3 is a block diagram an environment 112 for converting and importing data into a digital terminal device, such as a set top box or an electronic computer system, in one embodiment of the present invention. FIG. 3 shows, in one embodiment, a digital terminal device 100 coupled, via a communication connection 150, to a media reading apparatus, media reading apparatus 200b. Digital terminal device 100 of FIG. 3 is analogous to digital terminal device 100 of FIG. 2. Communication connection 150 of FIG. 3 is analogous to communication connection 150 of FIG. 2.

Media reading apparatus 200b is configured with a plurality of receiving slots, slot 299a and 299b, where each receiving slot in adapted to receive a particular media storage device, e.g., slot 299a is adapted to receive a media storage device 199a and slot 299b is adapted to receive a media storage device 199b. Media storage device 199a of FIG. 3 is analogous to media storage device 199a of FIG. 2. Media storage device 199b can, in one example, be an audio cassette. In another example, media storage device 199b can be a digital audio tape. It is noted that media reading apparatus 200b can be configured to receive and access nearly any type of media storage device currently available.

In the present embodiment, media reading apparatus 200b is shown configured with two media receiving slots, 299a and 299b. For each receiving slot present, there is an associated means to select the speed with which the data from an inserted media storage device can be read. Associated with slot 229b, and disposed beneath slot 229b is, in one embodiment, a rotatable dial mechanism 234 for selecting the speed with which the data can be read. Associated with slot 299a is a plurality of buttons 233 for selecting the speed with which data from a media storage device inserted in slot 299a can be read. It is noted that alternative means to select the speed with which the data in either slot, 299a or 299b, can be implemented, including toggle switches, levers, dials, and the like.

Referring collectively to media reading apparatus 200a of FIG. 2 and media reading apparatus 200b of FIG. 3 in one embodiment, both 200a and 200b can be configured to provide write back functionality. This means that after converting (digitally encoding) the data and importing that encoded data into a digital terminal device 100, and subsequent to any editing or alterations that a user may perform thereon, the edited digitally encoded data can be decoded, e.g., re-encoded digital-to-digital or digital-to-analog, back into its original format and rewritten back onto the media storage device from which it originally stored.

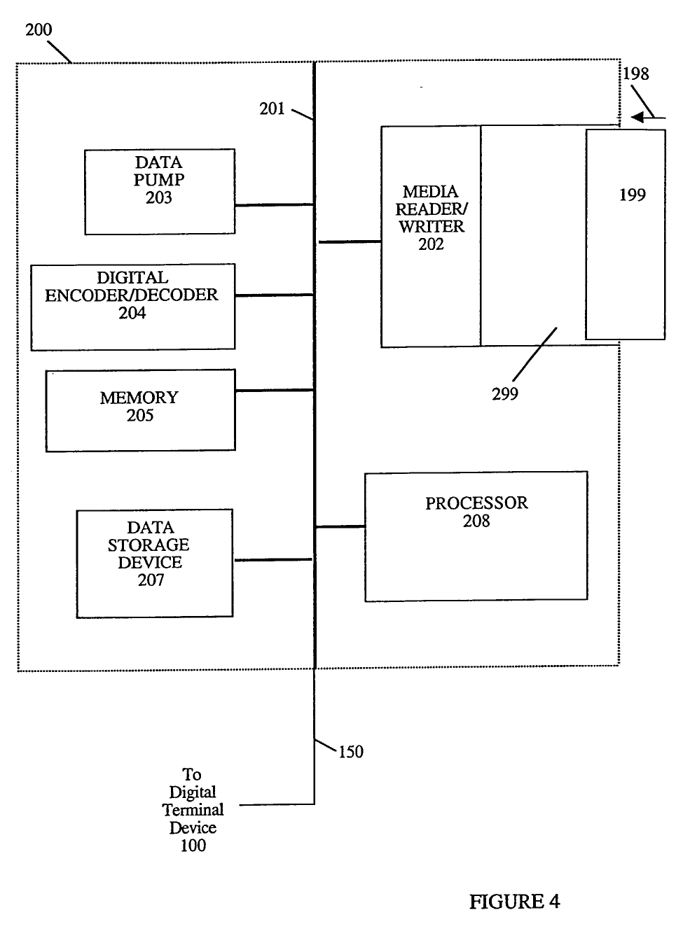

FIG. 4 is a functional block diagram of components and circuitry of a media reading apparatus, e.g., media reading apparatus 200, in one embodiment of the present invention. Media reading apparatus 200 includes an address/data bus 201 for communicating information, a processor 208 coupled with bus 201 for processing information and instructions, a memory unit 205 coupled with bus 201 for storing information and instructions for processor 208. Memory unit 205 can include a combination of flash memory, ROM (read only memory), RAM (random access memory), cache (high speed memory), and the like. Media reading apparatus 200 also includes a data storage device 207 coupled with the bus 201 for storing digitally encoded data, decoded data, information and instructions. Device 207 can, in one embodiment, be removable. Media reading apparatus 200 also includes a digital encoder/decoder 204 coupled with bus 201. Digital encoder/decoder 204 is for digitally encoding data and for decoding digitally encoded data. In one embodiment, encoder/decoder 204 can convert data from a received data storage device, e.g., data storage device 199a, into an MPEG-1 format. MPEG-1 has video quality comparable to VHS video tape quality. In another embodiment, encoder/decoder can convert data from a received data storage device, e.g., data storage device 199b, into MPEG-2 format. MPEG-2 has video quality comparable to DVD quality. Also included in media reading apparatus 200 is a data pump 203 coupled with bus 201. Data pump 203 is for synchronizing and transferring data from media reader 200 to a digital terminal device 100, and vice versa.

Media reading apparatus 200 of FIG. 4 also includes a media reader/writer 202 coupled with bus 201. Media reader/writer 202 is for reading data from a media storage device 199 inserted, as indicated by arrow 198, into receiving slot 299. Receiving slot 299 is disposed externally upon media reading apparatus 200, in one embodiment.

In the present embodiment, media reader/writer 202 is interposed between bus 201 and receiving slot 299. In another embodiment, media reader/writer 202 can be coupled with bus 201 and receiving slot 299 can be communicatively coupled with bus 201, and media reader/writer 202 can access data in a inserted media storage device 199 via bus 201.

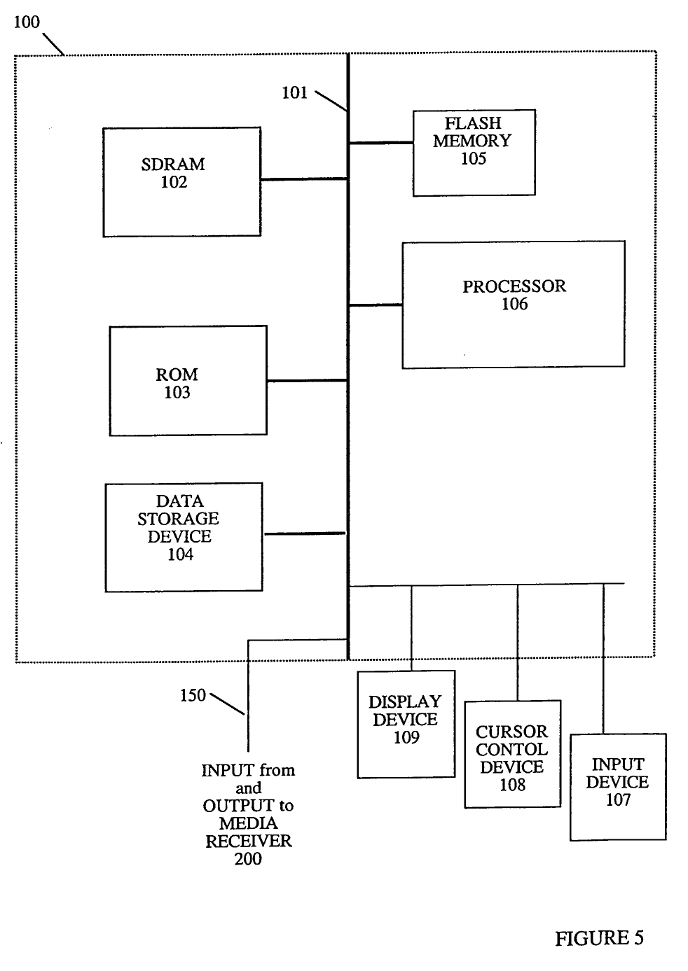

FIG. 5 is a functional block diagram of a digital terminal device 100, in one embodiment of the present invention. Digital terminal device 100 includes an address/data bus 101 for communicating information, a processor 106 coupled with the bus for processing information and instructions, a volatile memory 102 (e.g., random access memory, SDRAM) coupled with the bus 101 for storing information and instructions for the processor 106 and a non-volatile memory 103 (e.g., read only memory, ROM) coupled with the bus 101 for storing static information and instructions for the processor 106. Digital terminal device 100 also includes a data storage device 104 (e.g., a hard disk drive) coupled with the bus 101 for storing information and instructions. Device 104 can, in one embodiment, be removable.

Digital terminal device 100 also contains a display device 109 coupled to bus 101 for displaying information to the computer user. The display device 109 utilized with digital terminal device 100 can be a liquid crystal display device, a cathode ray tube (CRT), a field emission display device (also called a flat panel CRT) or other display device suitable for generating graphic images and alphanumeric characters recognizable to the user.

Also included in digital terminal device 100 is input device 107, e.g., a keyboard, which can communicate information and command selections to processor 106. Digital terminal device 100 can also include a cursor control or directing device (on-screen cursor control 108) coupled to bus 101 for communicating user input information and command selections to processor 106. In one implementation, on-screen cursor control device 108 is a mouse, joystick, scroll wheel, or other device that can communicate information and command selections to processor 106.

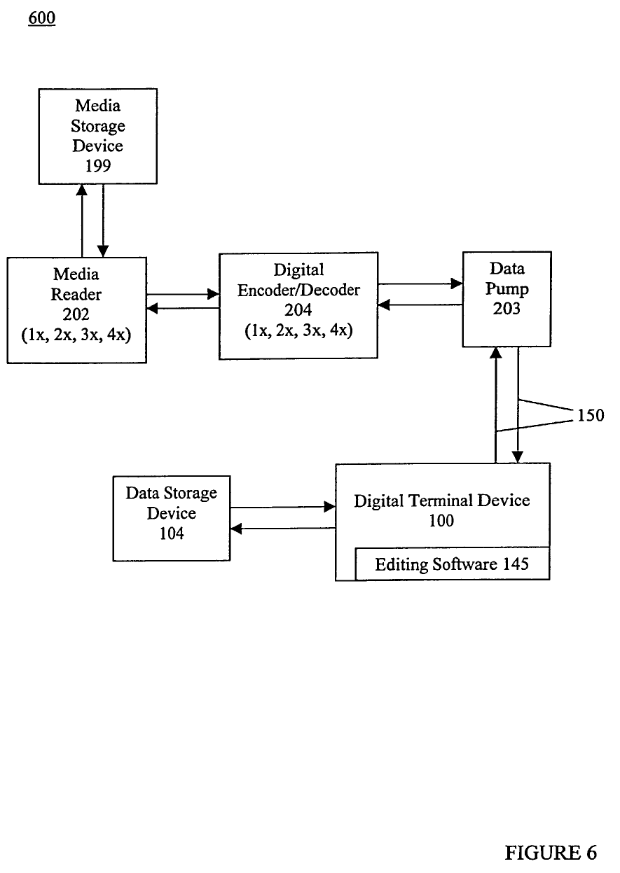

FIG. 6 is a data flow diagram 600 of data flow in a method for converting and importing data, from a media storage device inserted in a receiving slot of a media reading apparatus, to a digital terminal device for subsequent editing of the data, in accordance with one embodiment of the present invention. Data flow diagram 600 includes processes of the present invention which, in one embodiment, are carried out by processors and electrical components under the control of computer readable and computer executable instructions. The computer readable and computer executable instructions reside, for example, in data storage features such as computer usable memory 205 and data storage device 207 of media reading apparatus 200 of FIG. 4 and volatile memory 102, and/or computer usable non-volatile memory 103, and/or flash memory 105 digital terminal device 100 of FIG. 5. However, the computer readable and computer executable instructions may reside in any type of computer readable medium. Although specific data flows are disclosed in data flow diagram 600, such data flows are exemplary. That is, the present invention is well suited to performing various other steps or variations of the data flow recited in FIG. 6. Within the present embodiment, it should be appreciated that the data flow of data flow diagram 600 may be facilitated by software, by hardware, by a user, or by any combination of software, hardware, and user.

FIG. 6 shows a block data flow diagram 600 for encoding data and importing encoded data into a digital terminal device, e.g., digital terminal device 100 of FIGS. 2, 3, and 5. A removable media storage device 199, e.g., device 199a and/or 199b, is inserted into a media reading apparatus 200, and the data contained therein is read by a media reader/writer, e.g., media reader 202. In one embodiment, media reader 202 is enabled to write data to a data storage device, e.g., media reader/writer 202 of FIG. 4. In one embodiment, media reader 202 reads data at increased speeds when compared with conventional reading speeds. In one embodiment, media reader 202 can read data from a media storage device 199 at speeds of 1×, 2×, 3×, 4×, and faster.

Subsequent to and/or concurrent with media reader 202 reading data from media storage device 199, the read data is digitally encoded by a digital encoder/decoder, e.g., digital encoder/decoder 204 of FIG. 4. In one embodiment, encoder/decoder 204 is enabled to encode data at increased speeds when compared to conventional encoders. In one embodiment, encoder/decoder 204 can encode data at speeds of 1×, 2×, 3×, 4×, and faster. In one embodiment, encoder/decoder 204 can encode data into an MPEG 1 and/or an MPEG 2 (moving picture experts group) format.

With reference to FIG. 6, once the read data has been encoded by encoder/decoder 204, a data pump, e.g., data pump 203 synchronizes the encoded data and transfers the encoded data to a digital terminal device, e.g., digital terminal device 100, in one embodiment of the present invention.

A communication channel, e.g., communication channel 150, coupled between media reading apparatus 200 and digital terminal device 100 enables the transference of the encoded data. In one embodiment communication channel 150 is a high speed communication channel and is compliant with a HiSpeed USB (also referred to as USB2) bus standards. In another embodiment, communication channel 150 is compliant with IEEE 1394 bus standards.

Still referring to FIG. 6, the encoded data can, in one embodiment, be stored in a data storage device, e.g., data storage device 104 of digital terminal device 100. The encoded data can then be edited by a user using an editing program, e.g., editing software 145, of FIG. 6. In one embodiment, data storage device 104 is internal of digital terminal device 100. In one embodiment, data storage device 104 can be removable. In another embodiment, data storage device 104 can be external of digital terminal device 100.

It is noted that embodiments of the present invention are well suited to reversing the data flow as described above. In one embodiment, subsequent to editing of encoded data, the encoded data is transferred back to digital encoder/decoder 204, via data pump 203, where the encoded data is decoded into its original form. Media reader/writer 202, when so configured, can write the decoded digitally encoded and edited data onto the media storage device from which it originally came. In one embodiment, encoded/decoder 204 can decode encoded data at increased speeds, when compared with conventional decoder. In one embodiment, reader/writer 202 can write data to data storage device 199 at increased speeds, when compared to conventional writers.

It is further noted that in another embodiment, embodiments of the present invention are well suited to transfer recorded content received from a cable or satellite broadcast to media writer 202 for writing to a media storage device 199.

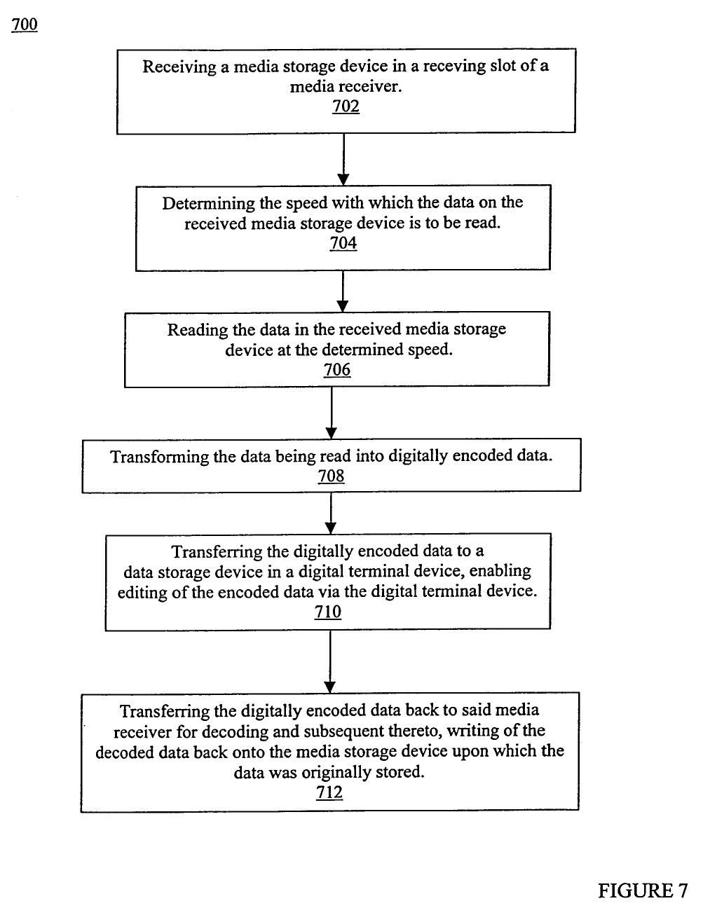

FIG. 7 is a flowchart 700 of steps performed in accordance with one embodiment of the present invention for converting and importing data, from a media storage device inserted in a receiving slot of a media reader, to a digital terminal device for subsequent editing of the data, in accordance with one embodiment of the present invention. Flowchart 700 includes processes of the present invention which, in one embodiment, are carried out by processors and electrical components under the control of computer readable and computer executable instructions. The computer readable and computer executable instructions reside, for example, in data storage features such as computer usable memory 205 and data storage device 207 of FIG. 4 and volatile memory 102, and/or computer usable non-volatile memory 103, and/or flash memory 105 of FIG. 5. However, the computer readable and computer executable instructions may reside in any type of computer readable medium. Although specific steps are disclosed in flowchart 700, such steps are exemplary. That is, the present invention is well suited to performing various other steps or variations of the steps recited in FIG. 7. Within the present embodiment, it should be appreciated that the steps of flowchart 700 may be performed by software, by hardware, by a user, or by any combination of software, hardware, and user.

In step 702 of FIG. 7, a media storage device, e.g., media storage device 199a or 199b, is inserted in a receiving slot, 299a or 299b, respectively, of a media reader 200a or 200b of FIGS. 3 and 4, respectively, in one embodiment of the present invention. In one embodiment, receiving slot 299 automatically initiates reading of the data contained in the inserted media storage device, and at a speed determined by the type of media storage device and the data contained therein. In another embodiment, reading is initiated manually by a user.

In step 704 of FIG. 7, the speed with which the data is to be read by a media reader, e.g., media reader 202 of FIG. 4, is determined, in accordance with one embodiment of the present invention. In one embodiment, subsequent to the insertion of the media storage device in a receiving slot 199, a user can select the reading speed, via a plurality of select buttons 233, as shown in FIG. 3, or via a select dial 234, as shown in FIG. 4. In another embodiment, the data reading speed can be dynamically determined by the type of media storage device 199 that is received in receiving slot 299.

In step 706 of FIG. 7, the data from the inserted media storage device 199 is read by a media reader/writer 202 of media reader 200. In one embodiment, media reader/writer 202 is configured as a read only device. In another embodiment, media reader 202 is configured with write functionality as well, e.g., media reader/writer 202 of FIG. 4. Data that has been read is transmitted to a digital encoder/decoder 204 disposed in media reader 200.

In step 708 of FIG. 7, the read data is then digitally encoded into a digital format in accordance with the format of the digital terminal device 100 into which the encoded data is to be exported. For example, if a digital terminal device 100 is configured for MPEG 2 format, then digital encoder/decoder 204 of FIG. 4 will encode the data in that particular format. If a digital terminal device 100 is configured for an alternative format, the media encoder/decoder 204 will encode the data into that alternative format. In one embodiment, the digital encoding of the data is done at a speed analogous to the read speed. In another embodiment, the digital encoding of the data can be done at a speed different than the read speed. In one embodiment, selection buttons 233 and/or selector dial (FIG. 4) can also be utilized to select the encoding speed. In another embodiment, an encoding selection mechanism can be disposed upon a surface of a media reader, similar to those shown in FIGS. 3 and 4, but adapted to select encoding speed rather that reading speed.

In step 710 of FIG. 7, subsequent to the digitally encoding of the data in the inserted media storage device, the encoded data is transferred to a data storage device, e.g., data storage device 104, of digital terminal device 100, in one embodiment of the present invention. The transferring of the data from media reader 200 to digital terminal device 100 is enabled by a high speed communication connection, e.g., communication connection 150 of FIGS. 2, 3, 4, and 5. A data pump, e.g., data pump 203 synchronizes the data and performs the transference of the data. Once the encoded data has been transferred to the data storage device 104, a user can make desired changes to the data, limited in part by the editing functionalities provided by the digital terminal device in which the encoded data is now stored. Editing of the encoded data can be accomplished by user interaction, via a display device 109, a cursor control device 108, and/or an input device 107, with digital terminal device 100.

In step 712 of FIG. 7, subsequent to the editing of the encoded data by a user, the encoded data can be stored in data storage device 104 in digital terminal device 100 and played for the enjoyment of the user, in one embodiment. In another embodiment, once the user has completed the editing, a copy of the encoded data can remain stored in the data storage device 104, while a copy of the encoded data can be synchronized and transferred back to the media reader, via data pump 203. Subsequent to the retransfer of the encoded data back to media reader 200, the encoded data can be decoded back into its original format, and then rewritten back onto the media storage device from which it came.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A media apparatus comprising:
a reading component enabled to read data from a media storage device at a selectable accelerated speed;
a digital encoder coupled with said reading component and adapted to digitally encode data read by said reading component at a selectable accelerated speed;
a data pump coupled with said digital encoder, said data pump for synchronizing encoded media with and for transfer to a digital terminal device; and
a high speed communication channel coupled to said data pump and said digital terminal device for enabling high speed transference of said encoded data to a data storage device of said digital terminal device.

2. The media apparatus of claim 1 further comprising a receiving component for receiving said media storage device.

3. The media apparatus of claim 2 further comprising a writing component coupled to said receiving component, said writing component for writing decoded data to said media storage device.

4. The media apparatus of claim 1 further comprising a writing component and a digital decoder coupled to said writing component and said data pump, said digital decoder adapted to decode digitally encoded data stored in said data storage device of said digital terminal device.

5. The media apparatus of claim 1 wherein said high speed communication channel is substantially compliant with a HiSpeed universal serial bus.

6. The media apparatus of claim 1 wherein said high speed communication channel is substantially compliant with an IEEE 1394 bus.

7. The media apparatus of claim 4 wherein said communication channel further enables high speed transference of digitally encoded data to said digital decoder, via said data pump, for decoding of said digitally encoded data, prior to writing data to said media storage device.

8. The media apparatus of claim 1 wherein said media storage device is an audio/video tape.

9. The media apparatus of claim 1 wherein said digitally encoded data is compatible with the data format of said digital terminal device, and wherein said format is a motion picture export group (MPEG) format.

10. The media apparatus of claim 1 wherein said digital terminal device is a set top box.

11. The media apparatus of claim 1 wherein said digital terminal device is an electronic computer system.

12. A media system, communicatively coupled to a digital terminal device, and comprising:
a reader/writer component adapted to read data from and adapted to write data to a media storage device at accelerated speeds;
a encoder/decoder component coupled with said reader/writer component, said encoder/decoder for digitally encoding data in said media storage device and for decoding digitally encoded data in said digital terminal device, wherein said encoding and said decoding are performed at accelerated speeds; and
a data pump adapted to transmit digitally encoded data to a data storage device in said digital terminal device, said data pump further adapted to transmit digitally encoded data received from said digital terminal device to said encoder/decoder for decoding and performed prior to writing decoded data to said media storage device by said reader/writer component.

13. The media system of claim 12 further comprising a receiving component for receiving said media storage device.

14. The media system of claim 12 further comprising a high speed communication channel between said digital terminal device and said media receiving system, said high speed communication channel enabling transference of digitally encoded data to said data storage device of said digital terminal device and transference of digitally encoded data to said encoder/decoder for decoding, prior to said reader/writer writing decoded data to said received media storage device.

15. The media system of claim 12 wherein data in said media storage device is an audio/video tape.

16. The media receiving system of claim 14 wherein said high speed communication channel is substantially compliant with a HiSpeed universal serial bus.

17. The media system of claim 14 wherein said high speed communication connection is substantially compliant with an IEEE 1394 bus.

18. A method of transforming data from one format into another format comprising:
reading data from a removable media storage device at a selectable high rate of speed, said reading performed by a reader/writer component communicatively coupled with a media reader;
encoding read data into said another format, said another format being a digitally encoded format and said encoding being a high speed encoding and performed by an encoder/decoder coupled with said reader/writer component and a data pump; and
transferring encoded data to a data storage device of a digital terminal device via a communication channel coupled between said media reader and said digital terminal device.

19. The method as recited in claim 18 further comprising transferring encoded data from said digital terminal device to said encoder/decoder for decoding of said encoded data.

20. The method as recited in claim 18 wherein said transferring further comprises synchronizing said encoded data with said digital terminal device, said synchronizing and said transferring of said encoded data performed by said data pump.

21. The method as recited in claim 19 further comprising writing decoded data to said media storage device, said writing performed by said reader/writer component.

22. The method as recited in claim 18 wherein said removable media storage device is an audio/video tape.

23. The method as recited in claim 18 wherein said communication channel is a high speed communication channel and is substantially compliant with a HiSpeed universal serial bus.

24. The method as recited in claim 18 wherein said communication channel is a high speed communication channel and is substantially compliant with an IEEE1394 bus.

25. The method as recited in claim 18 wherein said digital terminal device is a set top box.

26. The method as recited in claim 18 wherein said digital terminal device is an electronic computer system.

27. A playback device comprising:
a reader for accessing stored digital data on a removable storage medium, said reader for playing back said stored digital data at a selected one of a plurality of selectable playback rates;
an encoder coupled to said reader and for digitally encoding said digital data into digital encoded data;
a data pump coupled to said encoder and for synchronizing said digital encoded data; and
a transmission channel coupled to said data pump and for providing digital encoded and synchronized data to a storage device of a set-top-box.

28. A playback device as described in claim 27 further comprising a mechanical receiver for receiving said removable storage medium.

29. A playback device as described in claim 28 wherein said removable storage medium is a digital video cassette.

30. A playback device as described in claim 28 wherein said removable storage medium is a digital video disc (DVD).

31. A playback device as described in claim 28 wherein said transmission channel is a serial bus interface.

32. A playback device as described in claim 28 wherein said plurality of selectable playback rates comprise 1×, 2×, 3× and 4× the normal playback rate of said digital data.

33. A playback device as described in claim 28 wherein said digital encoded data is encoded according to the Moving Picture Experts Group (BEG) encoding format.
